(19) United States
(12) Patent Application Publication
(10) Pub. No.: US 2006/0271452 A1
(43) Pub. Date: Nov. 30, 2006

(54) System and method for relative-volatility linked portfolio adjustment

(76) Inventor: Panayotis Takis Sparaggis, New York, NY (US)

Correspondence Address: John M. Johnson;Carter Ledyard & Milburn LLP, 2 Wall Street, New Canaan, NY, 10005, US

(21) Appl. No.: 11/136,928

(22) Filed: May 25, 2005

(51) Int. Cl. G06Q 40/00

(52) U.S. Cl. 705/35

(57) ABSTRACT

A method of structuring a guaranteed financial product on a risk asset using a computer comprising: a) introducing a reference asset being another risk asset having a secondary derivative market which is better developed and more liquid than said secondary derivative market of said risk asset; b) analyzing and comparing the volatility level of said risk asset and of said reference asset over a predetermined time period; c) applying an asset adjustment when said volatility level of said risk asset exceeds a predetermined level defined by said volatility level of said reference asset; and d) removing said asset adjustment when said volatility level of said risk asset falls below said predetermined level defined by the volatility level attained in c).

### BACKGROUND OF THE INVENTION

In recent years, market volatility has increased the popularity and usage of “capital guaranteed” financial products. Typically, investors in these products are offered the opportunity to participate in a portion or form of the upside in an underlying market, security or fund, while bearing limited or zero principal risk to their investment over a certain time period.

From a structurer's (also referred as “issuer” or “underwriter,” e.g. a private bank who issues the structured product) standpoint, capital guaranteed products are often viewed as a combination of a zero-coupon bond plus a call option on an underlying financial instrument. For example, if the value of a zero-coupon bond returning 100 units of capital (any currency) in five years is currently 80 units, then the underwriter who receives 100 units from an investor can invest 20 units in a call option on the underlying instrument and 80 units in a zero-coupon bond, thereby being able to guarantee to return at least 100 units back to the investor at the end of the five years—plus the value of the call option in five years.

When the underlying instrument (also referred to as asset) is liquid, e.g., a stock, basket of stocks, or an equity index such as the S&P 500, the issuer can either buy the option in the open market or dynamically replicate its payoff by continuously trading the liquid underlying instrument. However, when the underlying instrument is less liquid, e.g. an actively managed hedge fund or fund of hedge funds with only monthly liquidity, or the underlying financial instrument has a very limited secondary derivative (option) market, the issuer has to devise a more sophisticated way to offer principal protection.

The most common way of offering principal protection to risk assets (such as actively managed funds) is the constant-proportion portfolio insurance model, know as the CPPI model¹. Using this model, the issuer invests in a combination of a zero-coupon bond and the risk asset, typically starting off by investing 100% of the notional in the risk asset, and subsequently reducing such investment to the risk asset and increasing the zero-coupon investment simultaneously should the risk asset's net asset value fall below a pre-defined threshold level, in a deterministic mechanical way. For example, the issuer may reduce its investment in the risk asset by 25% should the asset's net asset value fall 5% below its initial level. If the risk asset continues to appreciate in value, however, no such reduction is needed.
¹“Seeking Capital Protection through Portfolio Insurance”, Giancarlo Frugoli and Feminando Sarnaria, A Wealth Manager's Guide to Structured Products, Risk Books, 2004.

Effectively, the issuer compares the value of the risk-asset/zero-coupon portfolio to that of a pure zero-coupon investment to always maintain sufficient margin to protect itself from any potential risk asset depreciation, thereby ensuring that investors can still be paid back their full principal at maturity without an underwriting loss. The main disadvantage of the model is that the investor's participation in the upside of the risk asset (e.g. a fund) is not fixed, but is instead path-dependent. For example, if the fund suffers a substantial loss initially, then the issuer may have to decrease its investment in the fund significantly, which may then substantially reduce the investor's upside participation in a subsequent potential period of potential appreciation in the fund. As a result, it is possible that the fund appreciates over the duration of the structured product, yet the investor ends up receiving zero appreciation on their initial principal.

### SUMMARY OF THE INVENTION

The subject invention pertains to a system and method for structuring principal guaranteed products that uses a relative volatility measure to make adjustments on the underlying risk asset (e.g. an actively managed fund) when necessary, thereby ensuring that the risk asset volatility remains contained within a predefined range.

Structured products on liquid underlying risk assets such as broad market indices are issued in large numbers and large notional amounts by a number of issuers such as private banks. The subject invention significantly expands the opportunity to underwrite structured products on less liquid assets, including assets for which a secondary derivative market is limited or does not exist, such as actively managed funds. Specifically, the subject invention allows the issuer to effectively transfer the hedging of its volatility risk to a broader and more liquid market, where a variety of option instruments can be used to offload such volatility risk. Using the subject invention, pricing of a structured product on an asset for which a secondary derivative market may not even exist then effectively becomes as easy as pricing a standard call option on a liquid market with developed traded derivative products such as the S&P 500.

The CPPI model is not well suited for structuring principal guaranteed products on highly volatile assets for which a secondary derivative market is limited or does not exist. As mentioned before, the CPPI model may force the underwriter to substantially decrease its investment in the risk asset in the event the risk asset sharply depreciates in value at the initial phase of the duration of contract embedded in the structured product, thereby potentially limiting or eliminating the opportunity to fully recover such losses even if the underlying asset fully recovers its losses by the end of the contract. This potential for limited upside participation is less of a risk for products in which the underlying asset is not very volatile. The subject invention is indifferent to the volatility of the risk asset as long as this volatility is contained within a range fixed relative to the volatility of a liquid reference asset. As a result, the subject invention significantly broadens the universe of risk assets that can be handled by issuers in their structured product offerings.

In addition, the subject invention allows the issuer to offer a fixed upside participation (e.g. 60%) on the appreciation of the underlying risk asset. In contrast, the CPPI model can only offer principal protection; upside participation is variable.

Finally, the subject invention allows the issuer to hedge unexpected future changes (“gaps”) in the volatility of the risk asset resulting from unexpected and potentially large changes in future financial market volatility. Using a volatility transaction, such as a volatility swap, the issuer can effectively “lock-in” a level of expected volatility on the risk asset in pricing the product, offsetting gains/losses in the embedded call option of the structured product (resulting from the actual risk asset volatility being different than the level used in pricing the product) by corresponding losses/gains in a volatility transaction such as a volatility swap on the reference asset, as the two volatility levels are linked by design.

The subject invention specifically contemplates:

A method and system of structuring a guaranteed financial product on a risk asset using a computer comprising: a) introducing a reference asset, i.e. another risk asset having a secondary derivative market which is better developed than the secondary derivative market of the primary risk asset; b) analyzing and comparing the volatility levels of the primary risk asset and of the reference asset over a predetermined time period; c) applying an asset adjustment when the volatility level of the risk asset exceeds a predetermined level defined by the volatility level of the reference asset; and d) removing the asset adjustment when the volatility level of the risk asset falls below a predetermined level defined by the volatility level attained in c).

A method and system of structuring a guaranteed financial product on a risk asset using a computer comprising: a) introducing a reference asset, i.e. another risk asset possibly having a secondary derivative market which is better developed than that of the primary risk asset; b) analyzing and comparing the volatility levels of the primary risk asset and of the reference asset over a predetermined time period; c) applying an asset adjustment when the volatility level of the risk asset exceeds a predetermined level defined by the volatility level of the reference asset d) removing the asset adjustment when the volatility level of the risk asset falls below a predetermined level defined by the volatility level attained in c); and e) entering a volatility transaction such as a volatility swap to hedge (i.e. protect from) unexpected changes in the volatility of the reference asset beyond the predetermined level defined in c) which is used to price the structured product.

A method and system of structuring a guaranteed financial product on a risk asset using a computer comprising: a) analyzing historical volatility levels and correlations between the risk asset and potential reference asset candidates to select one of the reference asset candidates as the reference asset; b) introducing a reference asset, i.e. another risk asset possibly having a secondary derivative market which is better developed than that of the primary risk asset; c) analyzing and comparing the volatility levels of the primary risk asset and of the reference asset over a predetermined time period; d) applying an asset adjustment when the volatility level of the risk asset exceeds a predetermined level defined by the volatility level of the reference asset; and e) removing the asset adjustment when the volatility level of the risk asset falls below a predetermined level defined by the volatility level attained in c).

### BRIEF DESCRIPTION OF THE DRAWINGS

These and other subjects, features and advantages of the present invention will become more apparent in light of the following detailed description of a best mode embodiment thereof, as illustrated in the accompanying Drawings.

FIG. 1 is a logic process flow chart embodying the system and method of the subject invention.

### DETAILED DESCRIPTION OF THE PREFERRED EMBODIMENT

The subject invention pertains to a system and method for structuring principal guaranteed products that uses a relative volatility measure to make adjustments on the underlying risk asset (e.g. an actively managed fund) when necessary, thereby ensuring that the risk asset volatility remains contained within a predefined range.

Definitions

Investors

A variety of investors use structured products in their portfolios. These investors include high-net worth individuals, institutions such as corporations, endowments, foundations and pension plans, family offices, money managers, private partnerships and companies.

Issuer

Also known as structurer or underwriter, a legal entity that offers structured products to investors and backs its principal guaranteed obligation by its own credit or the credit of an affiliate or partner. Such issuers include commercial and investment banks, insurance companies, private banks and other financial institutions and their subsidiaries and partners.

Risk Asset

A financial instrument such as an equity index, commodity index, fund, or a combination of financial instruments underlying a structured offered by the issuer to investors. The performance of this instrument is used to define the potential appreciation of the structured note, as promised by the issuer. The issuer may make investments in the risk asset continuously or at preset time intervals, or liquidate part of its investment in the risk asset as the issuers feels necessary relative to its obligation to deliver a level of upside participation at a future date, i.e. the expiration date of the structured note.

Reference Asset

A financial instrument whose volatility is used by the issuer to define an acceptable range of volatility for the risk asset underlying a structured note. The issuer will provide an adjustment (or remedy) at times when the volatility of the risk asset exceeds such acceptable range.

Asset Adjustment

A mechanism introduced by the issuer of the note to restrict the volatility of the risk asset. For example, if the risk asset is an actively managed fund, the adjustment can be a reduction in the net exposure of the fund.

Volatility Measurement

A process used by the issuer to compare the volatility of the risk asset to a level defined by the volatility of the reference asset. For example, the issuer may continuously measure the risk asset volatility calculated over a trailing one-month window and compare it against the volatility of the reference asset over the same rolling time window.

Volatility Linked Transaction

A financial transaction, such as a volatility swap, initiated by the issuer to hedge its volatility risk, i.e. the risk of having the actually volatility of the risk asset, realized over the duration of the structured product, be materially different than the volatility level used initially in pricing the structured product.

Description

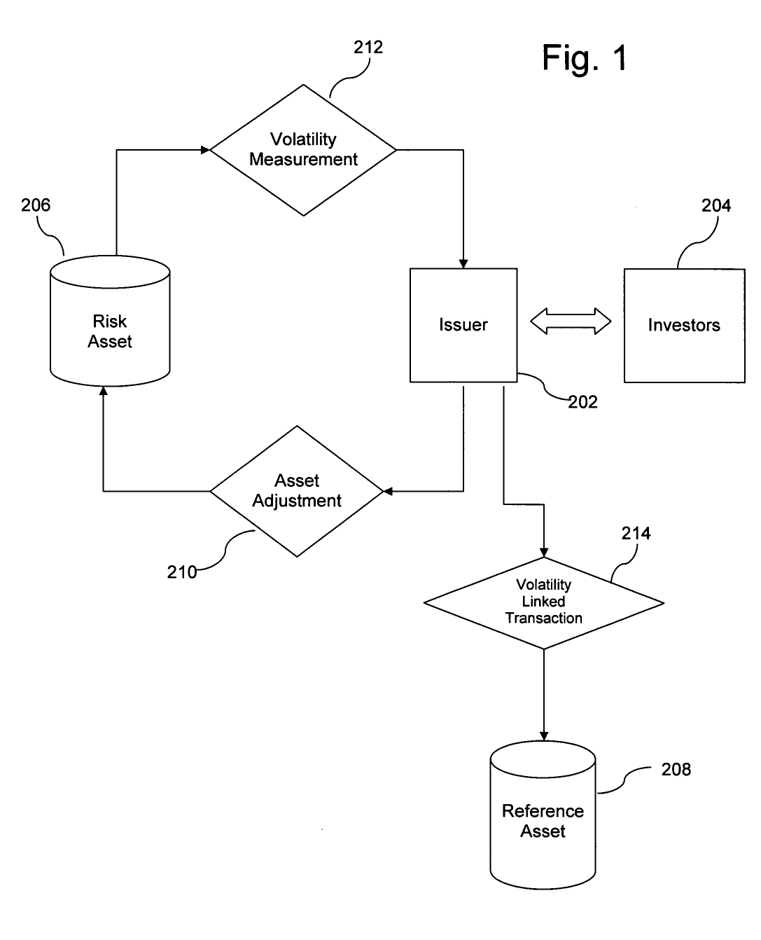

Referring to FIG. 1, an important aspect of the subject invention is the monitoring of the underlying risk asset 206 volatility 212 relative to the volatility 214 of another asset called the “reference asset 208,” typically a more liquid asset than the risk asset 206, and one for which a secondary derivative market is well developed. The issuer 202, who issued a structured product to investors 204, compares the volatility 212, 214 of the risk 206 and reference 208 assets periodically over a certain rolling time period (the “measurement window” e.g. a month) and directs an adjustment (or remedy) 210 to the risk asset 206 should the volatility 212 of the risk asset 206 exceed a certain level (or a function of) the volatility 214 of the reference asset 208. In that event, a remedy 210 is then imposed for a certain adjustment time and the volatility comparison between the two assets 206, 208 is performed again. The process is repeated until the risk asset's 206 volatility 212 falls below a level of function of the reference asset's 208 volatility 214 at which point the remedy 210 is removed.

For example, assume that the risk asset 206 is a hedge fund and the reference asset 208 is the S&P 500 index. In this example, the hedge fund 206 is restricted to have its average daily volatility 212, calculated over a rolling one-month measurement window, always be less than the corresponding S&P 500 208 volatility 214 over the same time period. Once the fund's 206 average volatility 212 exceeds the S&P 500 208 volatility 214, then the portfolio manager is directed to take remedy 210 by, for example, de-leverage 206 the fund by a fixed percent. The remedy 210 is applied to the fuid 206 for a predefined time period (e.g. a two-month window, called the “remedy window”) at the end of which volatilities 212, 214 are compared again over the measurement window. At that point, the fund 206 will be permitted to again increase leverage to its original level (remove remedy 210) should the fund's 206 volatility 212 drop below the S&P 500 208 level 214 over the measurement time window; otherwise the fund 206 is de-leveraged 210 again by the fixed percent over another remedy window. The process is repeated until the fund's 206 volatility 212 drops below that of the S&P 500 208, at which point the remedy 210 is removed.

The system and method of the subject invention uses a personal computer to monitor the volatilities 212, 214 of the risk 206 and reference 208 assets. A non-limiting example of the personal computer that can be employed to implement the system and method of the subject invention is an I.B.M.-type personal computer having, for example, a 3.2 GHz Intel Pentium 4 processor, commonly manufactured by Intel, Inc., 1 GB of memory, and 250 GB of internal hard drive storage. In order to accommodate a higher number of users a more powerful computer, or a grid of computers connected to each other in order to carry out parallel processing and load balancing, can be utilized. The computer, or computers, use an operating environment such as Enterprise Linux ES manufactured by Red Hat, Inc. or Windows Server 2003 manufactured by Microsoft Corp. Databases are managed using database software such as 10 g manufactured by Oracle Corp. A statistical software package (such as, for example SAS/STAT manufactured by SAS) will be used to calculate the volatility (variance) 212, 214 of a return series (e.g. daily returns) for the two assets 206, 208 over certain time windows (e.g., month). The same statistical software package will be used by the issuer to compare the historical volatility 214 and correlation of various reference assets 208 to that of the risk asset 206. The objective of this statistical analysis is to, first, select a reference asset 208 that is best correlated to the risk asset, and second, define the level of volatility 212 of the risk asset 206 (relative to the reference asset 208) that the risk asset 206 will be permitted to carry.

The subject invention offers a unique advantage to the issuer of the product. Specifically, the issuer can hedge its volatility risk 212 associated with the risk asset 206 underlying the structured product by transacting in another market, often more liquid, i.e. the market of the reference asset 208 for which a secondary derivative market often exists and is well-developed. Effectively, the subject invention is designed to “guarantee” that the volatility 212 of the risk asset 206 will not exceed a level related to the reference asset 208 over the duration of the product.

Embedded in the structured product is a call option on the underlying risk asset 206. Generally, any call option is dependent of five variables: the price of the underlying asset, the strike price, the risk-free interest rate, the time to expiration and the expected (implied) volatility of the risk asset. While the first four variables are deterministic the last one (implied volatility) is dynamic and the most difficult to assess for various risk assets 206. For example, the risk asset 206 may be dynamically managed (i.e. a managed fund) and its future volatility 212 may materially differ from its historical volatility.

Moreover, the volatility 212 of the risk asset 206 can also be difficult to dynamically hedge through trading, as the risk asset 206 may not be as liquid. Using the subject invention, however, the issuer 202 can price a structured product underwritten on a less liquid risk asset 206, or one for which a secondary derivative market is limited or does not exist, by transacting in the market of the reference asset 208.

As an example of a volatility transaction, the issuer may enter a volatility swap on the reference asset 208. In this example we further assume that the volatility of the volatility of the risk asset is restricted to be less than the volatility of the reference asset over the duration of the structured product. A volatility swap would allow the issuer 202 to hedge the risk of unexpected changes in future volatility 214 of the reference asset 208, and consequently unexpected changes in future volatility 212 of the risk asset 206 (whose volatility is linked to that of the reference asset 208). A volatility swap would have a payoff at expiration of:
(S−D)*n
where, S is the actual volatility 214 of the reference asset 208 over the life of the contract (ideally set to be equal to the life of the structured product), D is the volatility specified by the swap (e.g. a level equal to the implied (market) volatility 214 of the reference asset 208 at the time when the structured product was priced), and n is the notional amount of the swap (in any currency) per a unit of volatility.
Having entered a volatility swap, the issuer 202 can effectively hedge unexpected large changes in the future volatility 212 of the risk asset 206 resulting from market events or external events (e.g. catastrophic events such as wars) that would result in large increases in overall equity market volatility because the effect of such events can be captured by the volatility 214 of a market index than can be used as the reference asset 208. Such “gap” risk would have been difficult to hedge by dynamically trading the risk asset 206 even if the risk asset 206 was liquid enough. Using a volatility transaction, such as a volatility swap, the issuer 202 can effectively “lock-in” a level of expected volatility 212 on the risk asset 206 in pricing the structured product, thus offsetting gains/losses in the embedded call option of the structured product by corresponding losses/gains in the volatility swap on the reference asset 208 because the two volatility levels are linked by design.

### EXAMPLE

USD 100% Principal Protected Note on Fund ABC

Terms and Conditions

| | |
|---|---|
| Issuer | Bank XYZ, New York |
| Rating | AA |
| Notional Amount | USD 50,000,000 |
| Issue Price | 100% |
| Trade Date | 10 Aug. 203 |
| Issue Date | 11 Sep. 2003 |
| Maturity Date | 14 Sep. 2008 |
| Coupon | Zero |
| Redemption | 100% plus capital appreciation |
| Capital Appreciation | 65% × Max{0%, [(ABC_Final − |
| | ABC_Initial)/ABC_Initial]} |
| Calculation Agent | Bank XYZ, New York |
| Business Days | New York |
| Minimum Trade Size | USD 1,000,000 |
| Governing Law | New York |

Investment Restrictions

| | |
|---|---|
| Monitoring Agent | Bank XYZ, New York |
| Securities | US-exchange listed only |
| Concentration | Single Security less than 10% of ABC Fund's |
| | Net Asset Value (NAV) |
| Leverage | ABC Fund's net long exposure less than 100% |
| | (Permitted Leverage) of Fund's NAV |
| Variance | ABC Fund's Variance less than 100% of |
| | S&P 500 Variance |
| Measurement Window | 25 business days |
| Remedy Window | 25 business days |
| Asset Adjustment | 10% Reduction in ABC Fund's net long exposure |

ABC Fund's 206 trailing 25-day (Measurement Period) average variance 212 is compared to S&P 500 208 trailing average variance 214 at the end of each business day. If ABC Fund's 206 variance 212 exceeds the variance 214 of the S&P 500 208 then Permitted Leverage 210 is reduced by 10% over the ensuing 25-day period (Remedy Period), at the end of which the variances of ABC Fund and the S&P 500 are compared again over a Measurement Window. Then if the Fund's 206 average variance 212 falls below the variance 214 of the S&P 500 208 over the Remedy Period then Permitted Leverage 210 is reset to its initial level of 100% (Remedy is removed), otherwise Permitted Leverage is reduced by another 10% over a second Remedy Window. The process is repeated until ABC Fund's variance falls below that of the S&P 500, at which point the Remedy is removed and permitted leverage is reset to its initial level of 100%.

In this example, the structured note is priced to offer 65% participation on the appreciation of ABC fund 206 over a five-year period. The fund 206 needs to follow the above set of investment restrictions. Following issuance, the issuer 202 of the note will be monitoring the fund's 206 investment restrictions daily and will notify the manager of the fund 206 of any violations, which must then be immediately corrected. Should the manager fail to comply with such notification, the issuer 202 has the right to terminate the note early.

We claim:

1. A method of structuring a guaranteed financial product on a risk asset using a computer comprising:
a) introducing a reference asset being another risk asset having a secondary derivative market which is better developed and more liquid than said secondary derivative market of said risk asset;
b) analyzing and comparing the volatility level of said risk asset and of said reference asset over a predetermined time period;
c) applying an asset adjustment when said volatility level of said risk asset exceeds a predetermined level defined by said volatility level of said reference asset; and
d) removing said asset adjustment when said volatility level of said risk asset falls below said predetermined level defined by the volatility level attained in c).

2. The method of claim 1 further comprising entering a volatility transaction to hedge unexpected changes in volatility of said reference asset beyond said predetermined level of c).

3. The method of claim 2 wherein said volatility transaction is a volatility swap.

4. The method of claim 1 further comprising:
analyzing historical volatility levels and correlations between said risk asset and potential reference asset candidates to select one of said reference asset candidates as said reference asset.

5. The method of claim 1 wherein said risk asset is selected from the group consisting of hedge funds, fund of funds, mutual funds, closed-end funds, managed investment accounts, and partnerships.

6. The method of claim 1 wherein said reference asset is selected from the group consisting of equities, fixed-income securities, currencies, equity indices, fixed-income indices, currency indices, and economic variables and indices.

7. A method of structuring a guaranteed financial product on a risk asset using a computer comprising:
a) introducing a reference asset being another risk asset having a secondary derivative market which is better developed and more liquid than said secondary derivative market of said risk asset;
b) analyzing and comparing the volatility level of said risk asset and of said reference asset over a predetermined time period;
c) applying an asset adjustment when said volatility level of said risk asset exceeds a predetermined level defined by said volatility level of said reference asset;
d) removing said asset adjustment when said volatility level of said risk asset falls below said predetermined level defined by the volatility level attained in c); and
e) entering a volatility transaction to hedge unexpected changes in volatility of said reference asset above said predetermined level of c).

8. The method of claim 7 wherein said volatility transaction is a volatility swap.

9. The method of claim 7 further comprising:
analyzing historical volatility levels and correlations between said risk asset and potential reference asset candidates to select one of said reference asset candidates as said reference asset.

10. The method of claim 7 wherein said risk asset is selected from the group consisting of hedge funds, fund of funds, mutual funds, closed-end funds, managed investment accounts, and partnerships.

11. The method of claim 7 wherein said reference asset is selected from the group consisting of equities, fixed-income securities, currencies, equity indices, fixed-income indices, currency indices, and economic variables and indices.

12. A method of structuring a guaranteed financial product on a risk asset using a computer comprising:
a) introducing a reference asset being another risk asset having a secondary derivative market which is better developed and more liquid than said secondary derivative market of said risk asset;
b) analyzing and comparing the volatility level of said risk asset and of said reference asset over a predetermined time period;
c) applying an asset adjustment when said volatility level of said risk asset exceeds a predetermined level defined by said volatility level of said reference asset;
d) removing said asset adjustment when said volatility level of said risk asset falls below said predetermined level defined by the volatility level attained in c); and
e) analyzing historical volatility levels for said risk asset and potential reference asset candidates to select one of said reference asset candidates as said reference asset.

13. The method of claim 12 further comprising entering a volatility transaction to hedge unexpected changes in volatility of said reference asset beyond said predetermined level of c).

14. The method of claim 13 wherein said volatility transaction is a volatility swap.

15. The method of claim 12 wherein said risk asset is selected from the group consisting of hedge funds, fund of funds, mutual funds, closed-end funds, managed investment accounts, and partnerships.

16. The method of claim 12 wherein said reference asset is selected from the group consisting of equities, fixed-income securities, currencies, equity indices, fixed-income indices, currency indices, and economic variables and indices.

17. A system for structuring a guaranteed financial product on a risk asset using a computer comprising:
a) a component for introducing a reference asset being another risk asset having a secondary derivative market which is better developed and more liquid than said secondary derivative market of said risk asset;
b) a component for analyzing and comparing the volatility level of said risk asset and of said reference asset over a predetermined time period;
c) a component for applying an asset adjustment when said volatility level of said risk asset exceeds a predetermined level defined by said volatility level of said reference asset; and
d) a component for removing said asset adjustment when said volatility level of said risk asset falls below said predetermined defined by the volatility level attained in c).

18. The system of claim 17 further entering a volatility transaction to hedge unexpected changes in volatility of said reference asset beyond said predetermined level of c).

19. The system of claim 18 wherein said volatility transaction is a volatility swap.

20. The system of claim 17 further comprising:
a component for analyzing historical volatility levels and correlations between said risk asset and potential reference asset candidates to select one of said reference asset candidates as said reference asset.

21. The system of claim 17 wherein said risk asset is selected from the group consisting of hedge funds, fund of funds, mutual funds, closed-end funds, managed investment accounts, and partnerships.

22. The system of claim 17 wherein said reference asset is selected from the group consisting of equities, fixed-income securities, currencies, equity indices, fixed-income indices, currency indices, and economic variables and indices.

23. A system for structuring a guaranteed financial product on a risk asset using a computer comprising:
a) a component for introducing a reference asset being another risk asset having a secondary derivative market which is better developed and more liquid than said secondary derivative market of said risk asset;
b) a component for analyzing and comparing the volatility level of said risk asset and of said reference asset over a predetermined time period;
c) a component for applying an asset adjustment when said volatility level of said risk asset exceeds a predetermined level defined by said volatility level of said reference asset;
d) a component for removing said asset adjustment when said volatility level of said risk asset falls below said a predetermined level defined by the volatility level attained in c); and
e) entering a volatility transaction to hedge unexpected changes in volatility of said reference asset above said predetermined level of c).

24. The system of claim 23 wherein said volatility transaction is a volatility swap.

25. The system of claim 23 further comprising:
a component for analyzing historical volatility levels and correlations between said risk asset and potential reference asset candidates to select one of said reference asset candidates as said reference asset.

26. The system of claim 23 wherein said risk asset is selected from the group consisting of hedge funds, fund of funds, mutual funds, closed-end funds, managed investment accounts, and partnerships.

27. The system of claim 23 wherein said reference asset is selected from the group consisting of equities, fixed-income securities, currencies, equity indices, fixed-income indices, currency indices, and economic variables and indices.

28. A system for structuring a guaranteed financial product on a risk asset using a computer comprising:
a) a component for introducing a reference asset being another risk asset having a secondary derivative market which is better developed and more liquid than said secondary derivative market of said risk asset;
b) a component for analyzing and comparing the volatility level of said risk asset and of said reference asset over a predetermined time period;
c) a component for applying an asset adjustment when said volatility level of said risk asset exceeds a predetermined level defined by said volatility level of said reference asset;
d) a component for removing said asset adjustment when said volatility level of said risk asset falls below said predetermined level defined by the volatility level attained in c); and
e) a component for analyzing historical volatility levels for said risk asset and potential reference asset candidates to select one of said reference asset candidates as said reference asset.

29. The system of claim 28 further comprising entering a volatility transaction to hedge unexpected changes in volatility of said reference asset beyond said predetermined level of c).

30. The system of claim 29 wherein said volatility transaction is a volatility swap.

31. The system of claim 28 wherein said risk asset is selected from the group consisting of hedge funds, fund of funds, mutual funds, closed-end funds, managed investment accounts, and partnerships.

32. The system of claim 28 wherein said reference asset is selected from the group consisting of equities, fixed-income securities, currencies, equity indices, fixed-income indices, currency indices, and economic variables and indices.
